(19) United States
(12) Patent Application Publication
(10) Pub. No.: US 2006/0248974 A1
(43) Pub. Date: Nov. 9, 2006

(54) Rolling-element screw drive with deflection element

(76) Inventor: Michael Scholz, Poppenlauer (DE)

Correspondence Address: STRIKER, STRIKER & STENBY, 106 EAST NECK ROAD, HUNTINGTON, NY, 11743, US

(21) Appl. No.: 11/416,150

(22) Filed: May 2, 2006

(30) Foreign Application Priority Data
May 7, 2005 (DE) 10 2005 021 213.1

(51) Int. Cl. F16H 25/22

(52) U.S. Cl. 74/424.86

(57) ABSTRACT

A rolling-element screw drive has a spindle having a spindle groove on an outer circumference surface of the spindle, a nut having at least one helical nut groove with a constant screw diameter and provided on an inner circumferential surface of the nut, the helical nut groove and the spindle groove defining a threaded channel, the threaded channel and a return channel in the nut forming an endless circulatory channel, a number of rolling elements accommodated in the endless circulatory channel, at least one separate deflection element in which sections of the endless circulatory channel extend, the nut groove having ends extending in the separate deflection element.

### CROSS-REFERENCE TO A RELATED APPLICATION

The invention described and claimed hereinbelow is also described in German patent application DE 10 2005 021 213.1 filed on May 7, 2005. This German patent application, whose subject matter is incorporated here by reference, provides the basis for a claim of priority of invention under 35 U.SC. 119(a)-(d).

### BACKGROUND OF THE INVENTION

The present invention relates to a rolling-element screw drive with a deflection element.

Rolling-element screw drives of this type are known, e.g., from FR 1.436.798. FIGS. 1 through 4 in that publication show a rolling-element screw drive that includes a spindle 4 with a not-shown longitudinal axis and a nut 1. A helical nut groove is provided on the inner circumferential surface of nut 1 which, together with a spindle groove 3 on the outer circumferential surface of the spindle, defines a threaded channel. Together with a return channel 6, the threaded channel forms an endless circulatory channel in which a large number of rolling elements 2 is accommodated. A deflecting element 5 is also provided, in which sections of the endless circulatory channel extend.

With rolling-element screw drives of this type, the helical nut groove usually has a constant screw diameter, i.e., the uniform groove profile—which which can be designed as a Gothic arch, for example—is machined into the nut with a constant diameter along a helix. This is achieved, e.g., by grinding or tapping.

According to the teaching of FR 1.436.798, the endless circulatory channel has no projections or sharp bends anywhere along its entire length, thereby ensuring that the rolling elements roll with as little noise and wear as possible.

Particular attention is directed to the deflection point between the threaded channel and the return channel in the embodiment shown in FIGS. 7 through 11. The deflection point is the point in the endless circulatory channel at which the rolling elements are lifted out of the spindle groove by a lifting extension on the deflecting element and are transferred to the return channel. The actual deflection point is not specified exactly, due to the gap that unavoidably results between the spindle and the lifting extension. For this reason, the deflection point shall be referred to below as the intersection point or contact point between the center line of the threaded channel and the center line of the return channel.

According to FIG. 3 in FR 1 436 798, this deflection point is located exactly in the plane of end surface 7b of deflection element 5. Therefore, the return channel can have a simple circular cylindrical design at its junction with the deflection point, so that it transitions tangentially into the threaded channel, i.e., without any projections or sharp bends.

An embodiment of this type is not always possible with rolling-element screw drives with particularly large rolling elements, however, because there is not enough space available for a deflection element that has a sufficiently wide deflection curve. Instead, the deflection element must be enlarged slightly beyond the deflection point, so there is enough space available for the entire direction-reversing section of the return channel to fit inside the deflection element. With a deflection element of this type, however, a projection is formed between the return channel and the nut groove if the tangential, circular cylindrical return channel section is extended beyond the deflection point.

### SUMMARY OF THE INVENTION

The object of the present invention, therefore, is to prevent the formation of the projection described above.

This object is attained by the fact that the ends of the nut groove extend in the separate deflection element. As a result, the threaded channel can be guided up to the deflection point with a uniform cross section. From this point forward, the channel can be directed further in the known tangential manner, by way of which the nut groove transitions into the return channel without any projections or sharp bends.

It is obvious that, with a rolling-element screw drive according to the present invention, a run-in bevel is not provided at the transition between the deflection element and the nut main body, because doing so would produce another shoulder. Run-in bevels are often eliminated in rolling-element screw drives anyway, for reasons of cost.

The nut groove can transition into a straight section of the direction-reversal section of the return channel, so that, in the region of the lifting extension, the rolling elements do not have to be forced onto a curved track. The “running” noises of the rolling-element screw drive can be prevented as a result.

A refinement of the present invention provides that the direction-reversal section of the return channel has two sections with opposing directions of curvature. As a result of this embodiment, a greater deflection radius can be realized with a deflection element having a specified size, by way of which the running noises of the rolling-element screw drive are also diminished. To this end, a first gently bent return channel section has a direction of curvature that guides the rolling elements closer to the end surface of the nut. As a result, more space is made available in the axial direction for guidance purposes for the return channel section which follows, in the direction of motion of the rolling bodies, and which has a sharply opposed curvature. This second section now guides the rolling elements on a track parallel to the longitudinal axis of the spindle.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a perspective illustration of a rolling-element screw drive according to the present invention;

FIG. 2 shows a first partial sectional view of the rolling-element screw drive according to FIG. 1, the center line of the return channel being located in the cutting plane; and

FIG. 3 shows a second partial sectional view of the rolling-element screw drive according to FIG. 2, the cutting plane extending perpendicularly to the longitudinal axis of the spindle and containing the deflection point.

### DESCRIPTION OF THE PREFERRED EMBODIMENTS

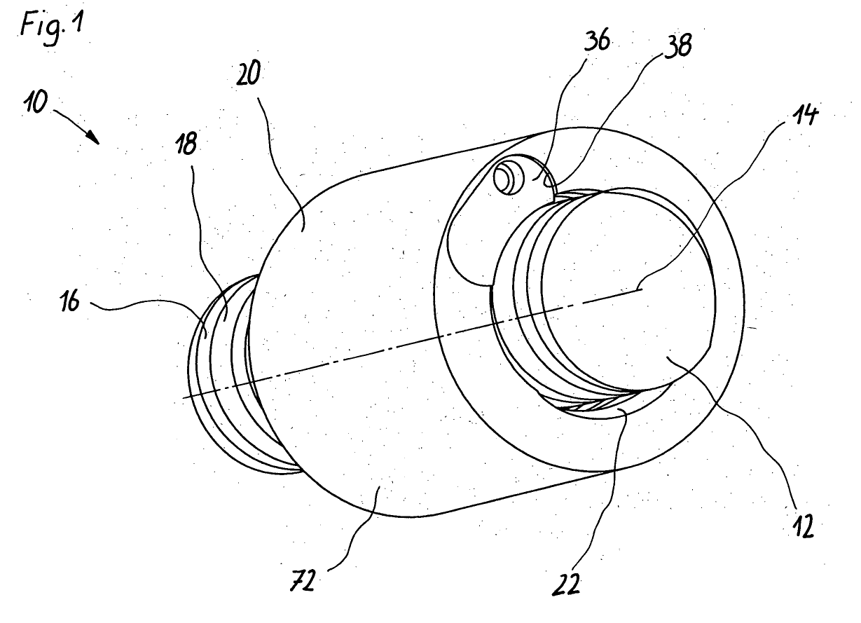

A rolling-element screw drive according to the present invention is labelled in general with reference numeral 10 in FIG. 1. It is composed of a nut 20 that encompasses a spindle 12 with a longitudinal axis 14. A helical nut groove 24 is machined into inner circumferential surface 22 of the nut. As viewed in the cross section with the axis, the nut groove has an arched profile that is machined into nut 20 along a helix with a constant diameter around longitudinal axis 14.

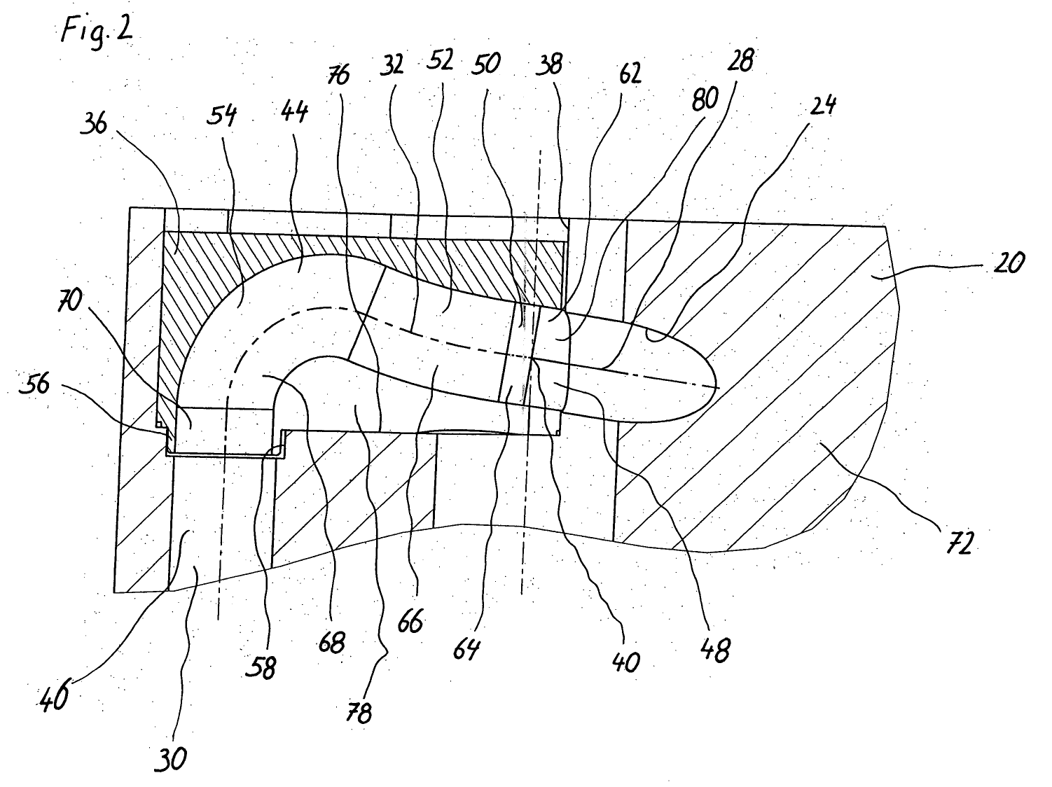

On its outer circumferential surface 16, spindle 12 has a spindle groove 18, which also has an arched profile, spindle groove 18 and nut groove 24 together defining a threaded channel 26. Furthermore, a return channel 30 is provided according to FIG. 2, which, together with threaded channel 26, forms an endless circulatory channel 34. A large number of not-shown rolling elements are accommodated in the form of balls in endless circulatory channel 34 such that they can move on rolling contact. The balls are inserted in threaded channel 26 with preload so the rolling-element screw drive operates without play. The balls roll with play in return channel 30.

Return channel 30 includes two direction-reversing sections 44 and a straight return tube 46 in the nut, which extends parallel to longitudinal axis 14 of the spindle. Each of the two direction-reversing sections 44 is located entirely in a separate deflection element 36 located in deflection element recesses 38 of nut main body 72. Deflection element recesses 38 are produced using an end mill and have the shape of a key groove.

Threaded channel 26 and return channel 30 each have a center line 28 and 32 that contact each other at deflection point 40 without any projections or sharp bends. Due to the shape of deflection element recess 38, which can be manufactured in a particularly cost-effective manner, in combination with a relatively large rolling element diameter, it is necessary to locate deflection point 40 inside the deflection element, so that entire direction-reversing section 44 of the return channel fits in the deflection element. Otherwise, the outer diameter of nut 20 would have to be enlarged to create enough space for deflection element 36.

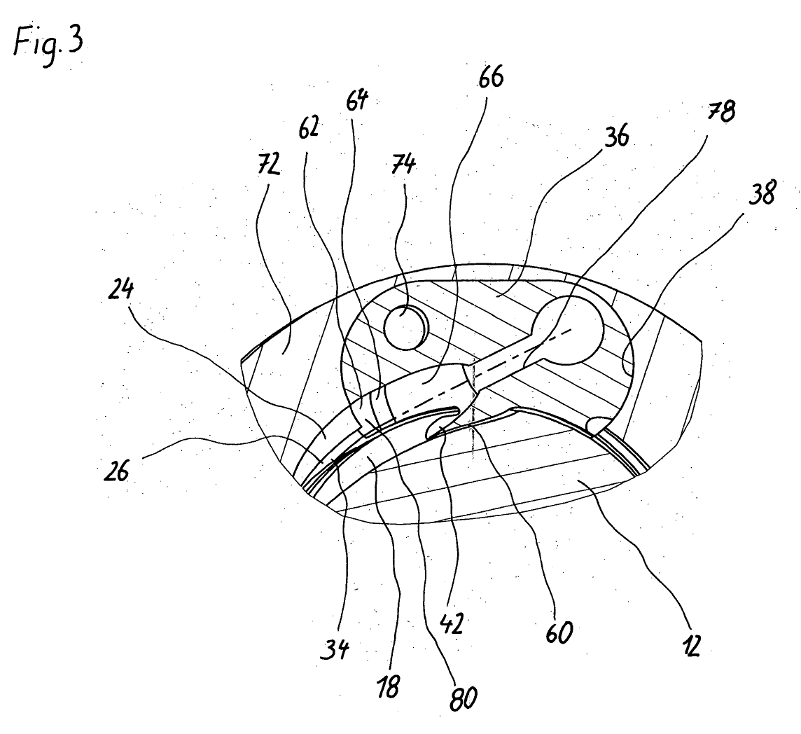

Deflection point 40 is the theoretical point at which the rolling elements are lifted out of spindle groove 18 and transferred to return channel. To this end—as shown in FIG. 3—a lifting projection 42 is provided on the deflection element, which engages in spindle groove 18. A small gap 60 is provided between lifting extension 42 and spindle groove 18 that makes it possible for the actual deflection point to deviate from theoretical deflection point 40 and, in fact, toward lifting extension 42. Gap 60 is necessary in order to prevent lifting extension 42 from damaging finely-machined spindle groove 18.

The part of return channel 30 that extends in deflection element 36 is composed of five sections, all of which transition into each other without any projections or sharp bends. A first section 62 is configured as a helical extension of nut groove 24 to deflection point 40. It is therefore end 80 of nut groove 24. The transition of nut groove 24 between nut main body 72 and deflection element 36 takes place without any projections or sharp bends, provided no unavoidable assembly errors exist.

A second section 64, which is designed as a circular cylinder, abuts first section 62. Third section 66 has an annular configuration with a slight curvature of the ring, to create more space for fourth section 68 with sharply opposed annular curvature. The actual reversal of direction of the track of the rolling elements in the direction of return tube 46 takes place in the fourth section. Direction-reversing section 44 of return channel described above is formed by second section 64, third section 66 and fourth section 68 of return channel 30 in deflection element 36.

Fifth section 70 of return channel 30 in deflection element 36 is the extension of return tube 46 and has a circular cylindrical configuration. To ensure that the fifth section is exactly flush with return tube, a tapped bore 58 is provided on the return tube, into which a centering projection 56 of the deflection element engages, centering projection 56 being configured concentrically with fifth section 70. Furthermore, a coaxial centering bore 74 is provided on nut main body 72 and on deflection element 36, through both of which a not-shown fit bolt passes, to orient first section 62 exactly flush with nut groove 24.

Entire return channel 30 inside deflection element 36 composed of plastic is produced using a spherical cutter. For this purpose, deflection element 36 has a narrow slot 78 for the shank of the spherical cutter on contact surface 76 of nut main body 72.

It will be understood that each of the elements described above, or two or more together, may also find a useful application in other types of constructions differing from the types described above.

While the invention has been illustrated and described as embodied in a rolling-element screw drive with deflection element, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A rolling-element screw drive, comprising a spindle having a spindle groove on an outer circumference surface of said spindle; a nut having at least one helical nut groove with a constant screw diameter and provided on an inner circumferential surface of said nut, said helical nut groove and said spindle groove defining a threaded channel, said threaded channel and a return channel in said nut forming an endless circulatory channel; a number of rolling elements accommodated in said endless circulatory channel; at least one separate deflection element in which sections of said endless circulatory channel extend, said nut groove having ends extending in said separate deflection element.

2. A rolling-element screw drive as defined in claim 1, wherein said return channel has a direction-reversing section, said nut groove in said deflection element transitions, without any projections or sharp bends, into said direction-reversing section of said return channel.

3. A rolling-element screw drive as defined in claim 2, wherein said direction reversing section of said return channel has a straight section, said nut groove transitioning into said straight section of said direction-reversing section of said return channel.

4. A rolling-element screw drive as defined in claim 2, wherein said direction-reversing section of said return channel has two sections with opposing directions of curvature.
